(19) United States
(12) Patent Application Publication
(10) Pub. No.: US 2025/0210988 A1
(43) Pub. Date: Jun. 26, 2025

(54) METHOD FOR CHECKING THE PLAUSIBILITY OF A PREDICTION

(71) Applicant: Siemens Aktiengesellschaft, München (DE)

(72) Inventors: Sebastian Schreck, Nürnberg (DE); Arvid Amthor, Grabfeld OT Nordheim (DE); Thomas Schütz, Fürth (DE); Oliver Dölle, Erlangen (DE)

(21) Appl. No.: 18/849,654

(22) PCT Filed: Feb. 20, 2023
(86) PCT No.: PCT/EP2023/054186

§ 371 Date: Sep. 23, 2024

(30) Foreign Application Priority Data
Mar. 23, 2022 (EP) 22163808.3

(51) Int. Cl. H02J 3/00; H02J 3/46

(52) U.S. Cl. CPC H02J 3/004; H02J 3/46

(57) ABSTRACT

A method for checking the plausibility of a prediction regarding an amount of providable energy in a local energy market having a processor, includes transmitting, to the processor, a first dataset having information about a prediction from a first energy producer regarding the amount of energy that a first energy generating installation of the first energy producer will provide in a defined period of time, transmitting, to the processor, one or more further datasets having information concerning influencing variables which could influence the amount of providable energy, calculating, using the processor, a probability that the forecast can be adhered to, based on the provided information regarding the influencing variables, and comparing, using the processor, the calculated probability with a predefined limit value. If the probability falls below the limit value, at the instigation of the processor, a corresponding indication is transmitted to the first energy producer.

The invention relates to a method for checking the plausibility of a prediction and to a plausibility checking device.

In a local overall energy system, e.g. in a district or municipality, there are n different energy subsystems, e.g. buildings, each with different energy installations, e.g. energy generation installations, consumption installations or storage installations. The most efficient possible allocation, i.e. assignment and distribution, of the energy generated and consumed in the overall system, as well as the exchange on the respective energy grid, is a central optimization/coordination problem. However, since each energy subsystem only has knowledge of its own energy installations, a central coordination platform is required for optimized exchange between the energy subsystems and the energy grid, while complying with the technical restrictions of the energy grid. Such a central coordination platform may be provided by a local energy market (=LEM), as described, for example, in DE102018221156A1 (Siemens Aktiengesellschaft) Jun. 6, 2020.

Participation in energy trading on the LEM, e.g. day-ahead trading or intraday trading, also involves risks, however. In the event of incorrect predictions of the amount of energy to be provided, additional costs may arise for the energy provider: If the energy provider is only able to provide the LEM with a smaller amount of energy than it previously proposed to the LEM, it must obtain and pay for the energy difference from other sources, e.g. a superordinate grid.

This problem is exacerbated in particular in the case of “disruptive” events, when the amount of energy that is able to be provided decreases unexpectedly due to faults or external influences, e.g. in the event of snow on a PV installation, a failure of a CHP plant or no wind for a wind turbine (PV=photovoltaic; CHP plant=combined heat and power plant).

The present invention is based on the object of improving a prediction with regard to an amount of energy that is able to be provided in a local energy market.

The object is achieved by a method having the features of independent patent claim 1 and by a device having the features of independent patent claim 11. Advantageous configurations and developments of the invention are specified in the dependent patent claims.

The method according to the invention is used for checking the plausibility of a prediction made by a first energy producer; here, the prediction states what amount of energy a first energy generation installation of the first energy producer will provide in a defined time period in a local energy market. In the text that follows, according to the language 19 used in a LEM, such a prediction is also referred to as a “bid”. According to the method, a first dataset containing information regarding the prediction made by the first energy producer is transmitted to a processor that is available to the local energy market for plausibility checking. According to the method, one or more further datasets containing information relating to influencing variables that could influence the amount of energy that is able to be provided are transmitted to the processor. The processor then calculates a probability of the prediction being able to be met. This probability is therefore able to be characterized by the term “confidence rating”. This probability calculation is carried out on the basis on the information provided with respect to the influencing variables. The processor then compares the calculated probability with a predetermined limit value. If the calculated probability falls below the limit value, the processor causes a corresponding notification to be transmitted to the first energy producer.

The method according to the invention and/or one or more functions, features and/or steps of the method according to the invention and/or its configurations may be computer-aided.

The plausibility checking device according to the invention is configured to carry out the method.

A fundamental concept of the present invention is that a superordinate entity, i.e. the plausibility checking device, is also referred to below as: a “monitoring system”, which checks the plausibility of the incoming predictions. One aspect of the invention is therefore a central unit (“intelligence”) of the LEM, which assigns a “confidence rating” to incoming energy provision offers. This monitoring system that forms this central institution of the LEM processes the incoming bids and information relevant to the plausibility check, such as installation information, weather information, measured power, for example, in order to determine the extent to which the incoming bids may foreseeably be met (“confidence rating”). The output obtained is thus a probability between 0 and 1, where 1 indicates that the bid is able to be fulfilled with a predicted probability of 100%. Subsequently, if one of the limit values has been fallen below, which may be, for example, 0.5, a warning is output to the first energy producer that has made the prediction that it should revise its bid again.

The invention increases overall the robustness of a LEM.

The early detection of disruptive events may improve the quality of the bids in terms of their subsequent compliance. This in turn allows better coordination within the LEM in order to possibly reduce the utilization of a superordinate grid.

The invention makes it possible to better estimate reserve capacities, e.g. storage batteries, and to use them more efficiently.

The invention reduces the additional costs due to prediction errors for the participants in the LEM. This in turn reduces the incentive or the need to place conservative bids in the LEM, e.g. only 75% of the predicted PV generation. As a result, local resource efficiency increases, since more energy generated from renewable sources is proposed or traded on the LEM, thus fully utilizing its potential. As a result, the LEM moves away from a business logic and more closely approximates physical reality.

Advantageous configuration and developments of the invention are specified in the dependent claims. The method according to the invention may also be developed here according to the dependent device claims, and vice versa.

According to one preferred configuration of the invention, the probability is calculated by means of a linear polynomial, e.g. according to

$$Y = {β}_{0} + {β}_{1} {x}_{1} + {β}_{2} {x}_{2} + … + {β}_{p} {x}_{p} .$$

The variables xₙ (where n=1, 2, . . . , p) are influencing variables, e.g. outside temperature, global radiation, angle of installation, cloud drift in the next 15 min. The βₙ are weighting factors of the influencing variables, where n=1, 2, . . . , p; the weighting factors here may be obtained from historical data by means of a logistic regression. β₀ represents a constant that may be necessary to correctly calculate the probability Y. The result Y is the probability sought: Y=0 means that the first energy generation installation fails completely and is not able to deliver any energy; Y=1 means that the first energy generation installation is able to completely deliver the predicted amount of energy.

According to one preferred configuration of the invention, the probability is calculated by means of a neural network with sigmoid as the activation function of the output layer. In this case, the model parameters are determined using binary cross-entropy as a cost function. Cross-entropy as a cost function is used only to determine the parameters (training of the model). The neural network no longer needs this function during “running operation”; in this case, the architecture of the output layer (sigmoid) ensures that a probability Y is output. The advantage is that this is a completely non-linear system, which is also able to map a linear polynomial, however.

According to one preferred configuration of the invention, the prediction is compared with one or more other predictions relating to other energy generation installations that are comparable with the first energy generation installation. In contrast to the previous procedure, in which each energy producer creates its own prediction without there being a comparison between the predictions, the forecasts are validated on the basis of comparable installations. The advantage of this is that even in the case of a “dumb” energy generation installation, i.e. without sensors of its own, it is possible to check whether its predictions are plausible on the basis of the forecasts of other energy producers with similar energy generation installations.

According to one preferred configuration of the invention, the spatial distribution of the first and the other energy generation installations is taken into consideration in order to detect weather influences. Nowadays, there are a very large number of prosumers: By way of example, private households are emerging as energy producers with their own PV rooftop installations. The invention makes use of the large number of measuring points or sensors available as a result and their extensive spatial distribution. The spatial distribution of the energy generation installations may be used to detect disruptive (local) weather influences more easily and also with a higher probability. By way of example, external influences occurring in individual energy generation installations, such as no wind, snowfall or larger cloud fronts, may be detected at an early stage and communicated to the other energy generation installations of the LEM. In this way, the predictive quality of renewable energy generation installations may be significantly improved.

According to one preferred configuration of the invention, the influencing variables comprise installation information of the first energy generation installation, e.g. geographical coordinates, orientation, location of installation and inclination angle of the first energy generation installation, and/or installation information of other energy generation installations.

For example, the different specifications for installation of the energy generation installations are able to be used. In the case of private snow-covered PV installations, it is often necessary, for example, to wait for a layer of snow covering PV modules and thus impairing the electricity production thereof, to either melt or slide off. Since both processes depend on both the orientation and the mounting angle (steepness) of the PV modules, these phenomena may be transferred very well to other energy generation installations and/or energy generation installation specifications. By way of example, this allows a very good forecast of the time from which a PV installation covered in snow will generate electrical energy again.

Not only the individual data from the respective energy producer, but also further (measurement) data from other energy producers are available to the LEM. If using installation information from other energy generation installations that resemble the first energy generation installation (same product, same or similar type), a characteristic behavior of another energy generation installation, prior to a failure of the other energy generation installations, may be used to predict an imminent failure of the first energy generation installation. If, for example, multiple energy producers are connected to the same CHP plant in the LEM, then a characteristic behavior exhibited by all of these CHP plants before a failure may be used to predict a failure of a CHP plant.

According to one preferred configuration of the invention, the influencing variables comprise weather data and/or weather forecasts. The spatial distribution of the energy generation installations may be used to detect disruptive (local) weather influences more easily and also with a higher probability. By way of example, external influences occurring in individual energy generation installations, such as no wind, snowfall or larger cloud fronts, may be detected at an early stage and communicated to the other energy generation installations of the LEM. The predictive quality of renewable energy installations may be significantly improved as a result.

According to one preferred configuration of the invention, the influencing variables comprise information relating to the amount of energy provided in the past by the first energy generation installation and/or by other energy generation installations. Therefore, a prediction made in the context of certain weather conditions may be compared with earlier predictions made in the context of the same weather conditions.

According to one preferred configuration of the invention, the influencing variables comprise predictions with respect to other energy generation installations of the first energy producer and/or the other energy producers. Therefore, a prediction made in the context of certain weather conditions and/or in the context of a certain configuration and/or state of an energy generation installation may be compared with earlier predictions made in the context of the same or similar 14 weather conditions and/or in the context of the same or a similar configuration and/or state of another energy generation installation.

According to one preferred configuration of the invention, revised second and further predictions made by the first energy producer, which are transmitted to the processor after one or more notifications have been transmitted to the first energy producer, are checked for plausibility again. In this case, notifications are transmitted to the first energy producer until the probability meets or exceeds the defined limit value. The advantage of this is that the quality of the predictions is checked and tracked in an ongoing manner, with the result that better coordination is achieved within the LEM.

According to one preferred configuration of the invention, incoming predictions are checked in an automated manner. The advantage of this is that the outlay that an operator of the LEM has to expend for the plausibility check is reduced.

According to one preferred configuration of the invention, methods of “transfer learning” are able to be applied, such that when connecting new energy producers to the LEM, relatively good predictive results may already be achieved with little training data available.

Further advantages, features and details of the invention will emerge from the exemplary embodiments described below and with reference to the drawings, in which, schematically and not to scale,

FIG. 1 shows an illustration of a classification of a plausibility check in a LEM;

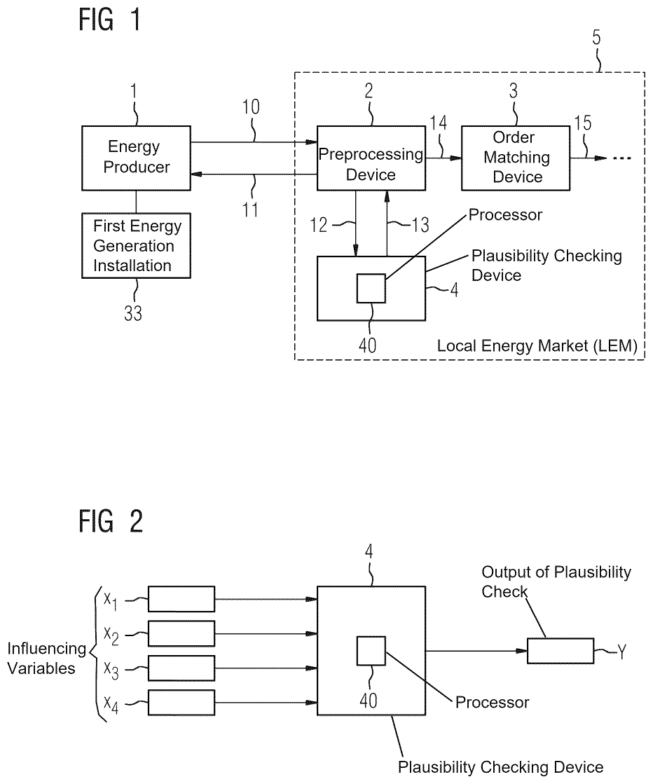

FIG. 2 shows an illustration of inputs and outputs of a plausibility check; and

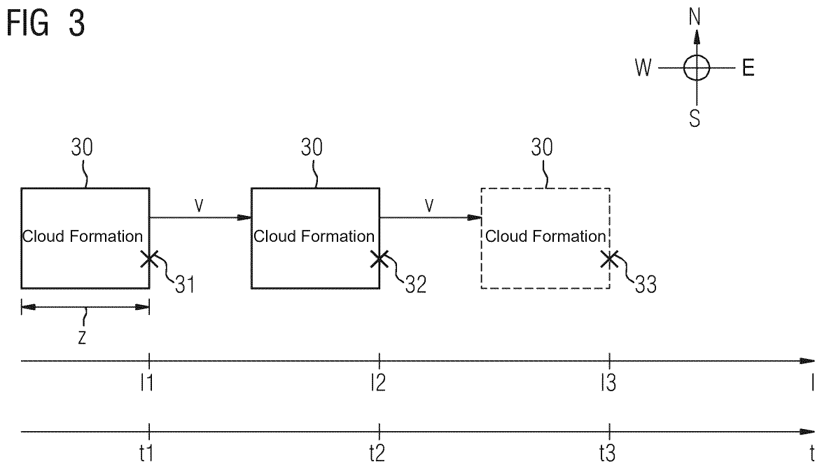

FIG. 3 shows an illustration of how a cloud formation influences multiple energy generation installations.

FIG. 1 shows an energy producer 1, which transmits 10 a dataset containing information relating to a prediction to a LEM 5, wherein the prediction makes a statement regarding an amount of energy that a first energy generation installation of the first energy producer 1 will provide in the LEM 5 in a defined time period, for example, from 0:00 h to 24:00 h of the following day. In the language of the LEM 5, such a prediction is referred to as a “bid”. The dataset arrives at a preprocessing device 2, where the dataset is subjected to preprocessing; by way of example, a check is carried out to determine whether the energy producer has a license to make a prediction in the LEM 5. The dataset is transmitted 12 from there to a plausibility checking device 4, which has a processor 40.

The plausibility checking device 4 also receives one or more further datasets containing information relating to influencing variables x₁, x₂, . . . , xₚ that could influence the amount of energy that is able to be provided. In a subsequent step, the plausibility checking device 4, using the processor 40, and on the basis of the provided information relating to the influencing variables, calculates a probability that the prediction will come true. The plausibility checking device 4 compares the calculated probability with a predetermined limit value in a subsequent step using the processor 40.

If the calculated probability falls below the limit value, the plausibility checking device 4 causes 13 the preprocessing device 2 to transmit a corresponding notification 11 to the first energy producer 1.

In the other case, in which the calculated probability reaches or exceeds the limit value, the plausibility checking device 4 causes 13 the preprocessing device 2 to further process the prediction and to transfer 14 it to an order matching device 3.

FIG. 2 shows an illustration of inputs and outputs of a plausibility check 4. A first input (influencing variable) x₁ is information relating to the first energy generation installation, such as coordinates, rated power, specifications for installation (e.g. orientation, location of installation, inclination angle), for example. A second input (influencing variable) x₂ is information from external providers such as weather forecasts and weather data, for example. A third input (influencing variable) x₃ is information relating to the generated power in the past; both values of the first energy generation installation and values of other comparable energy generation installations in the LEM 5 are of interest here. A fourth input (influencing variable) x₄ is information relating to the prediction, i.e. the proposed power; in addition to the prediction for the first energy generation installation, predictions for other comparable energy generation installations in the LEM 5 are also of interest. The output Y of the plausibility check 4 is a probability of the prediction foreseeably being able to be met.

FIG. 3 shows an illustration of how the spatial distribution of a first and other energy generation installations is taken into consideration in order to detect weather influences. During the day, a cloud formation 30 moves with a westerly wind of speed v over three photovoltaic energy generation installations 31, 32, 33 that are arranged in the west-east drifting direction of the cloud formation 30 at the locations 11, 12, 13. Here, the locations 13 and 12 are at a distance 13-12 from one another and the locations 12 and 11 are at a distance 12-11 from one another. Therefore, the cloud formation 30 reaches the three photovoltaic energy generation installations 31, 32, 33 successively at the times t1, t2 and t3. Since the cloud formation 30 has an extent z in its drifting direction, each of the three photovoltaic energy generation installations 31, 32, 33 is covered by the cloud formation 30 during a time period Δt=z/v.

If the cloud formation 30 does not produce precipitation or rain, the energy production of the three photovoltaic energy generation installations 31, 32, 33 will decrease at each of the times t1, t2 and t3 due to the onset of shade and remain at the decreased level during the time period Δt, before the energy production increases again due to direct sunlight after the cloud formation 30 has passed. It is possible, from the time t1 at which the energy production at the first photovoltaic energy generation installation 31 decreases, the distances 12-11 and 13-12, and the wind speed v at which the cloud formation 30 moves over the photovoltaic energy generation installations 31, 32, 33, to calculate the times t2, t3 at which the two other photovoltaic energy generation installations 32, 33 will also experience a decrease in the energy production. The same applies to energy production being resumed after the cloud formation 30 has passed.

If the cloud formation 30 produces snowfall, on account of the PV modules of the three photovoltaic energy generation installations 31, 32, 33 being covered with snow, the energy production of the three photovoltaic energy generation installations 31, 32, 33 will decrease at each of the times t1, t2 and t3, and remain at the decreased level until the PV modules are cleared of the cover of snow again, e.g. by sweeping, sliding off or melting. In the case of snowfall, at least the times t2, t3 at which energy production decreases are able to be calculated from the decrease in the first photovoltaic energy generation installation 31. The times at which the PV modules are cleared of snow again and energy production is resumed again cannot be derived solely from the speed of the cloud formation 30, since other influences, such as the position, orientation and inclination angle of the PV modules, also play a role here.

1-12. (canceled)

13. A method for checking the plausibility of a prediction regarding an amount of energy able to be provided in a local energy market having a processor (40), the method comprising:
transmitting, to the processor, a first dataset containing information regarding a prediction made by a first energy producer as to what amount of energy a first energy generation installation of the first energy producer will provide in a defined time period;
transmitting, to the processor, one or more further datasets containing information relating to influencing variables that could influence the amount of energy able to be provided;
using the processor to calculate a probability of the prediction being able to be met based on the information provided with respect to the influencing variables;
using the processor to compare the calculated probability with a predetermined limit value; and
upon falling below the limit value, using the processor to cause a corresponding notification to be transmitted to the first energy producer.

14. The method according to claim 13, which further comprises:
calculating the probability by using a linear polynomial:
$$Y = {β}_{0} + {β}_{1} {x}_{1} + {β}_{2} {x}_{2} + … + {β}_{p} {x}_{p}$$
wherein βₙ are weighting factors of the influencing variables, or
calculating the probability by using a neural network with sigmoid as an activation function of an output layer.

15. The method according to claim 14, which further comprises obtaining the weighting factors βₙ from historical data by using a logistic regression.

16. The method according to claim 13, which further comprises comparing the prediction with one or more other predictions relating to other energy generation installations being comparable with the first energy generation installation.

17. The method according to claim 16, which further comprises taking a spatial distribution of the first and the other energy generation installations into consideration to detect weather influences.

18. The method according to claim 16, which further comprises including installation information in the influencing variables.

19. The method according to claim 18, which further comprises selecting the installation information as geographical coordinates, orientation, location of installation and inclination angle of the first energy generation installation.

20. The method according to claim 13, which further comprises including at least one of weather data or weather forecasts in the influencing variables.

21. The method according to claim 16, which further comprises including information in the influencing variables relating to an amount of energy provided in the past by at least one of the first energy generation installation or the other energy generation installations.

22. The method according to claim 13, which further comprises including predictions in the influencing variables with respect to other energy generation installations of at least one of the first energy producer or other energy producers.

23. The method according to claim 13, which further comprises checking for plausibility of revised second and further predictions made by the first energy producer and transmitted to the processor after one or more notifications have been transmitted to the first energy producer, and transmitting notifications to the first energy producer until the probability meets or exceeds the predetermined limit value.

24. The method according to claim 13, which further comprises automatically checking incoming predictions.

25. A plausibility checking device, configured to carry out the method according to claim 13.
